(19) United States
(12) Patent Application Publication
(10) Pub. No.: US 2004/0136039 A1
(43) Pub. Date: Jul. 15, 2004

(54) Active and passive holographic optical based curved surface elements

(76) Inventor: Jefferson E. Odhner, Amherst, NH (US)

Correspondence Address: Jerry K. Mueller, Jr., Mueller and Smith, LPA, Mueller-Smith Building, 7700 Rivers Edge Drive, Columbus, OH, 43235, US

(21) Appl. No.: 10/744,973

(22) Filed: Dec. 22, 2003

Related U.S. Application Data
(63) Continuation-in-part of application No. 10/370,219, filed on Feb. 19, 2003.
Application No. 10/370,219 is a division of application No. 09/874,635, filed on Jun. 5, 2001, now Pat. No. 6,552,831.
Application No. 09/874,635 is a division of application No. 09/430,720, filed on Oct. 29, 1999, now Pat. No. 6,285,472.
Application No. 09/430,720 is a continuation-in-part of application No. 09/008,015, filed on Jan. 16, 1998, now abandoned.

(51) Int. Cl. G02B 5/32

(52) U.S. Cl. 359/15; 359/1

(57) ABSTRACT

A light bulb, composed of an envelope and an interiorly disposed light source, generates colored light to an observer by providing a reflective holographic optical element (HOE) diffraction grating associated with the envelope. The envelope also has an outer non-light transmissive area in which is disposed a light transmissive aperture. The HOE diffraction grating is oriented to receive and diffract light from the light source and reflect the diffracted light to the aperture for generating a select color of light to the observer. Such light bulb is made by disposing an apertured envelope of a light transmissive aperture disposed within a non-light transmissive area. A reflective holographic optical element (HOE) diffraction grating is associated with the envelope non-light transmissive area. The HOE diffraction grating is oriented to receive and diffract light from the light source and to reflect the diffracted light to the aperture for generating a select color of light to the observer.

### CROSS-REFERENCE TO RELATED APPLICATIONS

This application is a continuation-in-part application of Ser. No. 10/370,219 filed Feb. 19, 2003; which is a division of application Ser. No. 09/874,635, now U.S. Pat. No. 6,552,831; which is a division of application Ser. No. 09/430,720, now U.S. Pat. No. 6,285,472; which is a continuation-in-part of Ser. No. 09/008,015, filed Jan. 16, 1998, the disclosures of which are incorporated expressly herein by reference.

### STATEMENT REGARDING FEDERALLY SPONSORED RESEARCH

Not applicable.

### BACKGROUND OF THE INVENTION

The present invention relates to colored and decorative light bulbs and more particularly to achieving coloration and decoration using holographic optical diffraction gratings.

Conventional colored and decorative lights typically rely on tinting the glass envelope or applying a colored layer to the glass envelope of the light bulb. A light bulb, which could generate a myriad of bright colors would have an appeal to the market.

Holograms offer a technique by which a wealth of information can be displayed optically to an observer. If the hologram is of a diffractive layer and the diffractive layer has its effective spacing changed, then the holographic diffractive layer will generate a multitude of colors to the observer by dint of such grating spacing variation. This color generation is disclosed in U.S. Pat. No. 5,613,022, the disclosure of which is expressly incorporated herein by reference. In U.S. Pat. No. 6,285,472, an orb (e.g., Christmas ornament) has at least a portion of its surface covered with a holographic optical element diffraction grating, which diffracts light to emit color to an observer. In U.S. Pat. No. 6,552,831, an elongate light bulb retains a holographic optical element diffraction grating along its lengthwise extent adjacent a reflective strip, whereby the diffraction grating diffracts light to emit color to an observer.

One problem in the construction of reflective gratings on the envelope of a light bulb is that a multitude of rainbow patterns are generated and there is nothing to prevent such multiple rainbow patterns from overlapping on each other and combine to make white light. The present invention provides the solution to such problem.

### BRIEF SUMMARY OF THE INVENTION

The present invention in its broadest aspects relates to the employment of holographic optical elements (HOE), both passively and actively, on the outer envelope (e.g., glass) of a light bulb for generating colors or patterns of colors from the light source (e.g., white light source) disposed within the envelope. In order to eliminate or minimize pattern overlap, patterned reflective diffraction gratings are associated with the light bulb envelope. Such pattern can take the form of apertures. By using apertured holographic optical elements on the bulb envelopes, each bulb becomes an “optical system” whose design can be optimized for the maximum projection of rainbow patterns.

Broadly, then, a light bulb, composed of an envelope and an interiorly disposed light source, generates colored light to an observer by providing a reflective holographic optical element (HOE) diffraction grating associated with the envelope. The envelope also has an outer non-light transmissive area in which is disposed a light transmissive aperture. The HOE diffraction grating is oriented to receive and diffract light from the light source and reflect the diffracted light to the aperture for generating a select color of light to the observer.

The corresponding method for making such light bulb commences by providing an apertured envelope of a light transmissive aperture disposed within a non-light transmissive area. A reflective holographic optical element (HOE) diffraction grating is associated with the envelope non-light transmissive area. The HOE diffraction grating is oriented to receive and diffract light from the light source and to reflect the diffracted light to the aperture for generating a select color of light to the observer.

### BRIEF DESCRIPTION OF THE DRAWINGS

For a fuller understanding of the nature and objects of the present invention, reference should be had to the following detailed description taken in connection with the accompanying drawings in which:

FIG. 1 depicts a light bulb having a spherical envelope with a grating HOE on the surface that has been selectively metalized so that the bulb has an array of non-metalized holes;

FIG. 2 shows the ray tracing of the bulb of FIG. 1 for one of the apertures;

FIG. 3 depicts a light bulb having a spherical envelope with a grating HOE on the surface that has been selectively metalized so that the bulb has an array of non-metalized slits;

FIG. 4 shows the ray tracing of the bulb of FIG. 3 for one of the slits;

FIG. 5 depicts a light bulb having a spherical envelope with a grating HOE arranged to maximize the diffracted light output and minimize any output that is not diffracted; and

FIG. 6 shows the ray tracing of the bulb of FIG. 5;

The drawings will be further described below.

### DETAILED DESCRIPTION OF THE INVENTION

By orienting each HOE diffraction grating with an aperture a desired color of light is emitted from the light bulb to the observer regardless of the orientation of the bulb with respect to the observer. All HOE diffraction gratings can diffract the same color or different colors can be diffracted through different apertures to create special effects. In fact, patterns can be generated by proper orientation of the apertures born by the bulb envelope. It is even possible to have, for example, the bottom of the bulb envelope transparent and the top of the bulb envelope apertured for generating white light downwardly, for example, onto a desktop and red (or other color light) generated upwardly from the same light bulb. There number of combinations of patterns that can be created by the present invention is limited only by the imagination of man.

By making the actual bulb envelope (usually glass) carry the holographic pattern, the light source (which serves as the reference beam for the applied hologram) is fixed relative to the holographic diffraction pattern grating. Such orientation means that the diffracted light will always be at maximum efficiency and require no angle adjustment.

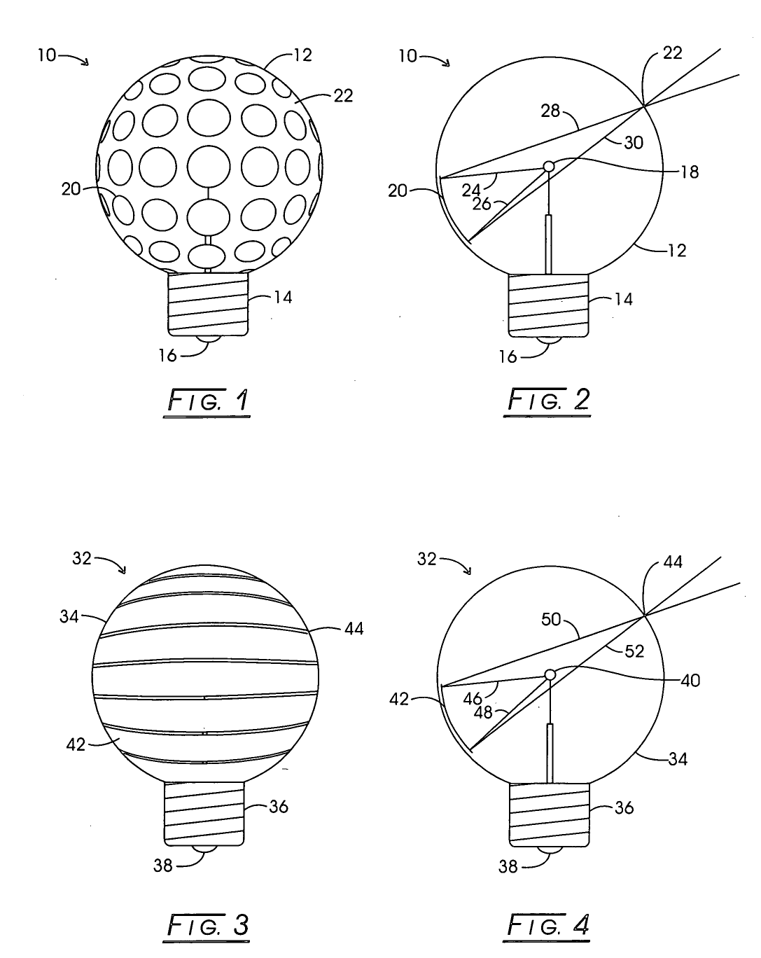

Referring initially to FIG. 1, a light bulb, 10, is composed of a spherical envelope, 12, and a base, 14, made to screw into a conventional light socket wherein an electrical contact, 16, supplies electricity to a filament, 18 (see FIG. 2), which emits light when resistively heated. A plurality of reflective HOE diffraction gratings, typified by circular HOE diffraction grating 20 (see also FIG. 2), are spaced about envelope 12. Light transparent apertures (e.g., light transmissive areas), such as aperture 22 (see also FIG. 2), also are disposed about envelope 12.

A ray tracing of the light rays emitted by filament 18 is depicted in FIG. 2. It will be seen that outer rays 24 and 26 strike reflective HOE diffraction grating 20 and reflected rays 28 and 30, respectively, converge at aperture 22 to provide maximum color intensity for the observer. Similar associations of one or more reflective HOE diffraction gratings with other apertures may be provided in similar fashion with similar ray tracings being present.

An alternative embodiment can be seen in FIG. 3, wherein a light bulb, 32, is composed of a spherical envelope, 34, and a base, 36, adapted to screw into a conventional light socket wherein an electrical contact, 38, supplies electricity to a filament, 40 (see FIG. 4), which emits light when resistively heated. A plurality of reflective HOE diffraction grating bands, typified by reflective HOE diffraction grating band 42 (see also FIG. 4), are spaced about envelope 34. Light transparent apertures (e.g., light transmissive areas), such as aperture band 44 (see also FIG. 4), also are disposed about envelope 34.

A ray tracing of the light rays emitted by filament 40 is depicted in FIG. 4. It will be seen that outer rays 46 and 48 strike reflective HOE diffraction grating 42 and reflected rays 50 and 52, respectively, converge at aperture 44 to provide maximum color intensity for the observer. Similar associations of one or more reflective HOE diffraction gratings with other apertures may be provided in similar fashion with similar ray tracings being present.

It will be appreciated that the configuration or shape of each reflective HOE diffraction grating is not a limitation of the present invention and the shapes shown in FIGS. 1 and 3 are illustrative only. In order for an observer to see maximum diffracted light, each reflective HOE diffraction grating is associated with at least one aperture. More than one reflective HOE diffraction grating may be associated with one aperture in order to blend colors, if necessary, desirable, or convenient.

The comments are true with respect to the shape of the bulb envelope. Any configuration or shape of bulb can be adapted in accordance with the precepts of the present invention from, inter alia, spherical, elongate, tubular, etc. The particular shape of envelope in the drawings is for convenience in illustrating the present invention and is not a limitation of the invention.

It will be observed that restricting the light output of the bulb to be apertured translates into a single color being emitted from the bulb for viewing by an observer. In other words, adjacent diffracted light rays cannot interfere with other adjacent diffracted light rays and cancel out the desired color(s), a result that may occur in the absence of the inventive apertured envelope design.

For any design of bulb, aperture, and reflective HOE diffraction grating, the color(s) projection can be enhanced by the following unique design criteria:

(a). Reduce the size of the filament. The ideal situation to get the maximum color projection is to have the light emitted from a single point in space. Alternatively, the filament should be tightly wound and small. As much as is possible, the long filament direction should be in line with the grating lines of the reflective HOE diffraction grating element.

(b). Use apertures to limit the grating projections. This will create a more vivid rainbow projection by reducing the number of projected rainbows that overlap.

(c). Generate the rainbow projections from diffractive reflective surfaces. This will give higher efficiency than transmitting through a transmissive grating embossed on the glass. The diffractive reflective surface can be generated by embossing the grating into the light bulb and then aluminizing it.

(d). Concentrate the light from the filament into smaller apertures. Light from the filament is radiated in all directions. This light should be collected and reflectively diffracted to project out small apertures on the bulb. The light concentration can be accomplished by a focusing holographic optical element or by a curved reflective grating. Smaller apertures will allow better pure color projection and fewer overlapping rainbow projections.

(e). Position the filament further from the grating. The filament position relative to the grating affects the dispersion angle. In general, brighter colors can be generated using a smaller angle if the filament is located further away from the grating.

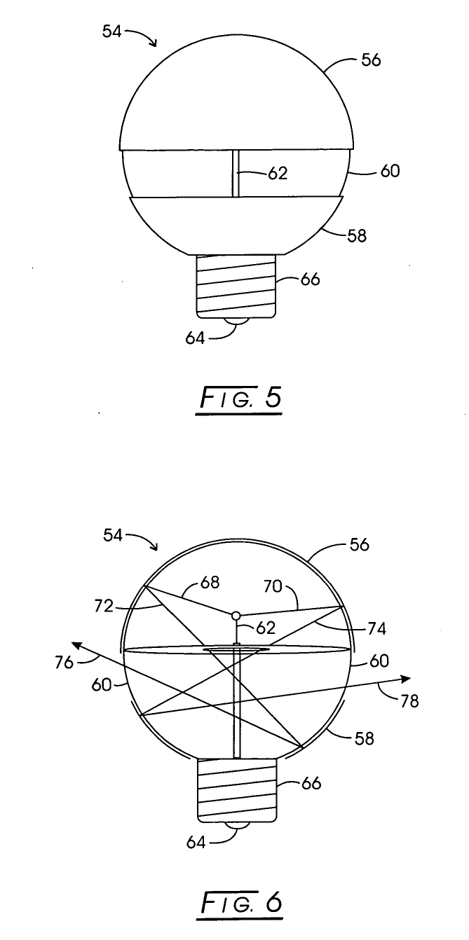

FIG. 5 shows an optical system built into the bulb to maximize the diffracted light output and minimize any output that is not diffracted. This is accomplished for a bulb, 54, having its upper surface coated (inside or outside) with a reflective (e.g., metalized) reflective surface, 56, and its lower surface coated (inside or outside) with a reflective HOE diffraction grating, 58. Disposed between said upper and lower reflective surfaces is an optically transmissive slit, 60. Again, this bulb is conventional with an internally disposed filament, 62 (see also FIG. 6), in electrical contact with a contact, 64, disposed within a base, 66, adapted to be screwed into a conventional light socket.

A ray tracing of the light rays emitted by filament 62 is depicted in FIG. 6. It will be seen that rays, 68 and 70, strike upper reflective surface 56 and are reflected rays, 72 and 74, respectively, strike reflective HOE diffraction grating 58, with reflected rays, 76 and 78, respectively, converging at aperture 60 to provide maximum color intensity to the observer.

Several variations of the bulb configurations illustrated in the drawings readily come to mind. For example, the filament could be a small bulb (halogen, metal halide, resistive element, etc.) with an envelope surrounding the filament. Also, the upper portion of the bulb could be entirely transparent to produce white light and the lower portion of the bulb could be apertured to produce colored light. This configuration would be stunning on, for example, white carpet. The skilled artisan, no doubt, will readily think of numerous other configurations that could be constructed in accordance with the precepts of the present invention.

To amplify on techniques for creating the reflective HOE diffraction element in the bulb envelope, such envelope can be heated up to the point where the glass (or plastic) is in a plastic state at which time a spherical nickel master can be pressed into the glass. The relief grating on the spherical nickel would be transferred into the glass and become permanent as glass envelope cools.

Alternatively, the bulb envelope could be covered with a photoresist, which then is exposed with a laser in such a way as to create a holographic diffraction pattern in the photoresist. Upon development of the diffraction grating, a relief pattern of the grating would be formed (places where the light constructively interfered creates a peak or valley depending upon whether a positive or negative photoresist was used). After a photoresist pattern has been formed, the glass exposed areas can be ion beam milled into the glass or chemically etched, for example, with perchloric acid or another suitable glass etchant to render the grating permanently into glass envelope.

A silver halide (light sensitive) emulsion also could be deposited onto the glass envelope (in a manner similar to the way silver halide emulsions are put onto glass plates), so that, after being exposed with a laser in such a way as to create a holographic diffraction grating, the emulsion could be developed and then would reconstruct when the light bulb was turned on.

Thereafter, the HOE diffractive grating can be metalized, for example, to make it reflective. Metallization is the preferred technique for creating a reflective surface, but other techniques known in the art also could be used.

While the invention has been described with reference to a preferred embodiment, those skilled in the art will understand that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In this application all units are in the metric system and all amounts and percentages are by weight, unless otherwise expressly indicated. Also, all citations referred herein are expressly incorporated herein by reference.

claim:

1. A light bulb which generates select colored light to an observer, and formed of an outer envelope and an interiorly disposed light source, which comprises: a reflective holographic optical element (HOE) diffraction grating associated with said envelope, said envelope having an outer non-light transmissive area within which is disposed a light transmissive aperture, said HOE diffraction grating oriented to receive and diffract light from said light source and to reflect said diffracted light to said aperture for generating a select color of light to said observer.

2. The light bulb of claim 1, wherein said envelope bears a plurality of HOE diffraction gratings associated with a plurality of apertures.

3. The light bulb of claim 1, wherein said light source flickers.

4. The light bulb of claim 1, wherein said envelope is made from a glass.

5. The light bulb of claim 1, wherein said apertures are circular.

6. The light bulb of claim 1, wherein said apertures are elongate slits.

7. The light bulb of claim 1, a portion of which generates white light and a portion of which generates said colored light.

8. The light bulb of claim 1, which has an upper reflective surface and a lower surface bearing said HOE diffraction gratings with an aperture disposed therebetween.

9. The light bulb of claim 1, wherein said envelope is transparent or translucent.

10. The light bulb of claim 2, wherein each said HOE diffraction grating produces about the same color light.

11. A method for making a light bulb which generates select colored light to an observer, and which is formed of an outer envelope and an interiorly disposed light source, which comprises the steps of:
(a) providing an apertured envelope comprising a light transmissive aperture disposed within a non-light transmissive area;
(b) associating a reflective holographic optical element (HOE) diffraction grating with said envelope non-light transmissive area; and
(c) orienting said HOE diffraction grating to receive and diffract light from said light source and to reflect said diffracted light to said aperture for generating a select color of light to said observer.

12. The method of claim 11, wherein said envelope bears a plurality of HOE diffraction gratings associated with a plurality of apertures.

13. The method of claim 11, wherein said light source flickers.

14. The method of claim 11, wherein said envelope is made from a glass.

15. The method of claim 11, wherein said apertures are circular.

16. The method of claim 11, wherein said apertures are elongate slits.

17. The method of claim 11, a portion of which generates white light and a portion of which generates said colored light.

18. The method of claim 11, which has an upper reflective surface and a lower surface bearing said HOE diffraction gratings with an aperture disposed therebetween.

19. The method of claim 11, wherein said envelope is transparent or translucent.

20. The method of claim 12, wherein each said HOE diffraction grating produces about the same color light.
